(19) United States
(12) Patent Application Publication
(10) Pub. No.: US 2008/0158214 A1
(43) Pub. Date: Jul. 3, 2008

(54) Method of driving plasma display panel

(75) Inventors: Dongki Paik, Yongin-si (KR); Jongrae Lim, Anyang-si (KR); Tae Heon Kim, Seoul (KR); Wootae Kim, Yongin-si (KR); Sung Chun Choi, Anyang-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/647,413

(22) Filed: Dec. 29, 2006

(51) Int. Cl. G06F 3/038

(52) U.S. Cl. 345/211

(57) ABSTRACT

A method of driving a plasma display panel is disclosed. According to a negative sustain driving method for a plasma display panel using a negative sustain voltage, the negative sustain voltage and the ground level voltage are alternately applied to each of scan electrode Y and sustain electrode Z in a sustain period, and the negative sustain voltage is first applied to the sustain electrode Z.

### BACKGROUND

1. Field

This document relates to a method of driving a plasma display panel.

2. Related Art

A plasma display panel (PDP) displays an image comprising a character or a graphic, by exciting phosphors using ultraviolet rays of a wavelength of 147 nm generated at the time of discharging an inert mixture gas of helium and xenon (He+Xe) or neon and xenon (Ne+Xe).

FIG. 1 is a perspective view illustrating the structure of a three-electrode AC surface discharge type PDP in the related art.

Referring to FIG. 1, the three-electrode AC surface discharge type PDP comprises a scan electrode 11 and a sustain electrode 12 formed on an upper substrate 10, and an address electrode 22 formed on a lower substrate 20.

The scan electrode 11 and the sustain electrode 12 have transparent electrodes 11a and 12a, respectively, and the transparent electrodes are formed of Indium-Tin-Oxide (ITO), for example. The scan electrode 11 and the sustain electrode 12 have metal bus electrodes 11b and 12b, respectively, which are formed to reduce resistance. An upper dielectric layer 13a and a protection film 14 are laminated on the upper substrate 10 having the scan electrode 11 and the sustain electrode 12 formed thereon.

On the upper dielectric layer 13a are accumulated wall charges generated during the discharge of plasma.

The protection film 14 serves to prevent the upper dielectric layer 13a from being damaged due to sputtering generated during the discharge of plasma, and enhance emission efficiency of secondary electrons. The protection film 14 is generally formed of magnesium oxide (MgO).

Meanwhile, a lower dielectric layer 13b and barrier ribs 21 are formed on the lower substrate 20 on which the address electrode 22 is formed. A phosphor layer 23 is coated on a surface of the lower dielectric layer 13b and the barrier ribs 21.

The address electrode 22 is formed to cross the scan electrode 11 and the sustain address 12. The barrier ribs 21 are formed parallel to the address electrode 22 and serve to prevent ultraviolet rays and a visible ray generated by discharge from leaking to adjacent discharge cells.

The phosphor layer 23 is excited by ultraviolet rays generated during the discharge of plasma to generate any of the red, green and blue visible rays.

An inert mixed gas, such as He+Xe or Ne+Xe for discharging is injected into discharge spaces of the discharge cells, which are provided between the upper/lower substrates 10 and 20 and the barrier ribs 21.

Such a PDP driving method is divided into a selective writing method and a selective erasing method according to whether discharge cells selected by the address discharge at address sections emit light or not.

In the selective writing method, the entire screen is turned-off at a reset section, and then discharge cells selected at the address section are turned-on.

FIG. 2 illustrates driving waveforms of PDP in accordance with a driving method of a selective writing method in the related art.

Referring to FIG. 2, the PDP is driven in each of periods which can be divided into a reset period for initializing the entire screen, an address period for selecting a cell, a sustain period for sustaining the discharge of the selected cell, and an erase period for erasing wall charges.

In the reset period, a rising ramp waveform is simultaneously applied to all of scan electrodes Y in a setup period. Discharge occurs in the cells of the entire screen due to the rising ramp waveform.

Due to the setup discharge, positive wall charges are accumulated on address electrodes A and sustain electrodes Z and negative wall charges are accumulated on the scan electrodes Y.

In the setdown period, a falling ramp waveform that starts to fall from a positive voltage lower than the peak voltage of the rising ramp waveform to thus fall to a ground voltage GND or a negative specific voltage level after the rising ramp waveform is supplied, generates weak erase discharge in cells to erase a part of the excessively formed wall charges.

The wall charges to the amount that can stably generate address discharge uniformly reside in the cells due to the setdown discharge.

In the address period, a negative scan pulse Scan is sequentially applied to the scan electrode Y, at the same time, a positive data pulse data is applied to the address electrodes A in synchronization with the scan pulse.

When difference in voltage between the scan pulse and the data pulse is added to the wall voltage generated in the reset period, address discharge is generated in the cell to which the data pulse is applied.

Wall charges to the amount that can generate discharge when a sustain voltage is applied are formed in the cells selected by the address discharge.

A positive DC voltage is supplied to the sustain electrode Z to reduce the difference in voltage between the sustain electrodes Z and the scan electrode Y in the setdown period and the address period such that erroneous discharge between the sustain electrodes Z and the scan electrodes Y is not generated.

In the sustain period, sustain pulses are alternately applied to the scan electrodes Y and the sustain electrodes Z. In the cells selected by the address discharge, the wall voltage in the cells is added to the sustain pulse such that the sustain discharge, that is, display discharge is generated between the scan electrodes Y and the sustain electrodes Z whenever each sustain pulse is applied.

After the sustain discharge is completed in the scan electrodes Y, a ramp waveform is supplied to the sustain electrodes Z to erase the wall charges that reside in the cells of the entire screen.

In the driving method for plasma display panel described above, a sustain pulse having a high voltage is used for the discharge of panel. As shown in FIG. 2, a voltage, +Vs is used with the ground voltage as a reference. When the discharge is initialized and sustained using such a high voltage, high voltage FETs are needed.

The high voltage FET is an important factor to increases the cost of the PDP, and causes a high possibility of erroneous discharge since it generates driving errors when the PDP is driven at a high voltage. Accordingly, a variety of researches to reduce the driving voltage of the PDP and to normally drive it at a low power are in progress.

There is a negative sustain method in a PDP driving method using a low power.

FIG. 3 illustrates driving waveforms in a negative sustain method in the related art.

In a negative sustain driving, negative voltage is applied to the upper electrodes (Y electrode, Z electrode) and the ground voltage is applied to the A electrode, so that positive charges move to the upper electrodes to collide with an MgO protection film of the upper electrode, thereby emitting secondary electrons. The secondary electrons have an influence on surface discharge occurred subsequently and serve to be a seed of the surface discharge, resulting in smoother discharge.

As such, due to the difference in voltage between the upper electrode and the A electrode, opposed discharge is generated therebetween. Further, since secondary electron emission increases due to the opposed discharge, the surface discharge is generated in a smoother manner.

However, it is difficult to effectively apply the negative sustain driving method in the related art to a PDP structure whose electrode gap is high. That is, while most of currently commercialized PDP products roughly have electrode gaps of 50 to 100 μm, long gap structures whose electrode gap is approximately 100 μm or more are recently used to increase discharge efficiency and stabilize driving characteristics. At this time, when the negative sustain driving method in the related art is applied, there is a problem in that it is not possible to reduce the sustain voltage under the reference voltage, and drive the PDP having the long gap structure effectively or stably.

### SUMMARY

In one aspect, a method of driving a plasma display panel comprise alternately applying a negative sustain voltage and a ground level voltage to each of a scan electrode and a sustain electrode during a sustain period, wherein the negative sustain voltage maybe first applied to the sustain electrode.

The scan electrode and the sustain electrode may be spaced with a predetermined gap therebetween.

The gap between the scan electrode and the sustain electrode may range from 100 μm to 400 μm.

Voltage having the same polarity may be applied to each of the scan electrode and the sustain electrode during a reset period.

The voltages having the same polarity applied to the scan electrode and the sustain electrode may be positive voltages.

In the voltages applied to the scan electrode and the sustain electrode in the reset period, the voltage applied to the scan electrode may be higher than the voltage applied to the sustain electrode.

In falling voltages in a setdown period of the reset period, the voltage applied to the scan electrode is higher than that applied to the sustain electrode, and the slope of the sustain electrode may be easier than that of the scan electrode.

The slope of the falling voltage may be 2V/μm or less.

Before applying the negative sustain voltage to the sustain electrode, a negative sustain ramp pulse having a magnitude, that may be less than a magnitude of the negative sustain voltage, may be applied to the sustain electrode.

In another aspect, a method of driving a plasma display panel comprise applying a negative sustain voltage to a sustain electrode and then a scan electrode during a sustain period and applying a negative sustain ramp pulse having a voltage of a magnitude, that may be less than a magnitude of the negative sustain voltage, to the sustain electrode before applying the negative sustain voltage to the sustain electrode.

A gap between the scan electrode and the sustain electrode may be more than a height of a barrier rib partitioning a discharge cell.

The scan electrode and the sustain electrode may range from 100 μm to 400 μm.

The gap between the scan electrode and the sustain electrode may range from 150 μm to 350 μm.

The negative sustain ramp pulse may be maintained for a period of time equal to or less than 5 μs.

A difference between the magnitude of the voltage of the negative sustain ramp pulse and the magnitude of the negative sustain voltage may range from 5V to 20V.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention

FIG. 1 is a perspective view illustrating the structure of a three-electrode AC surface discharge type PDP in the related art;

FIG. 2 illustrates driving waveforms of PDP in accordance with a driving method of a selective writing method in the related art;

FIG. 3 illustrates driving waveforms in a negative sustain method in the related art;

FIG. 4 illustrates waveforms of a negative sustain driving in a sustain period in accordance with the present invention;

FIG. 5 illustrates waveforms in a negative sustain driving method in accordance with an embodiment of the present invention;

FIG. 6 illustrates waveforms in a negative sustain driving method in accordance with another embodiment of the present invention;

FIG. 7 illustrates waveforms in a negative sustain driving method in accordance with still another embodiment of the present invention; and

FIGS. 8a and 8b are a view for comparing light waveforms in a negative sustain driving waveform in accordance with embodiments of the present invention.

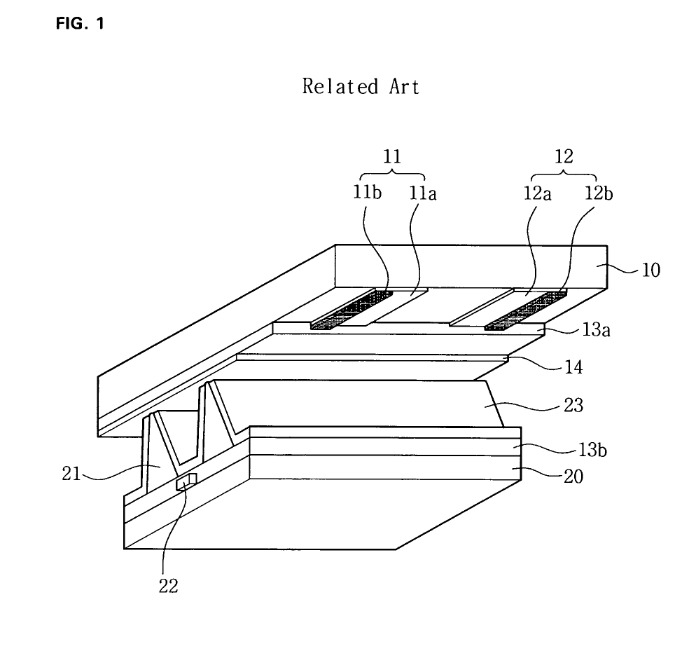

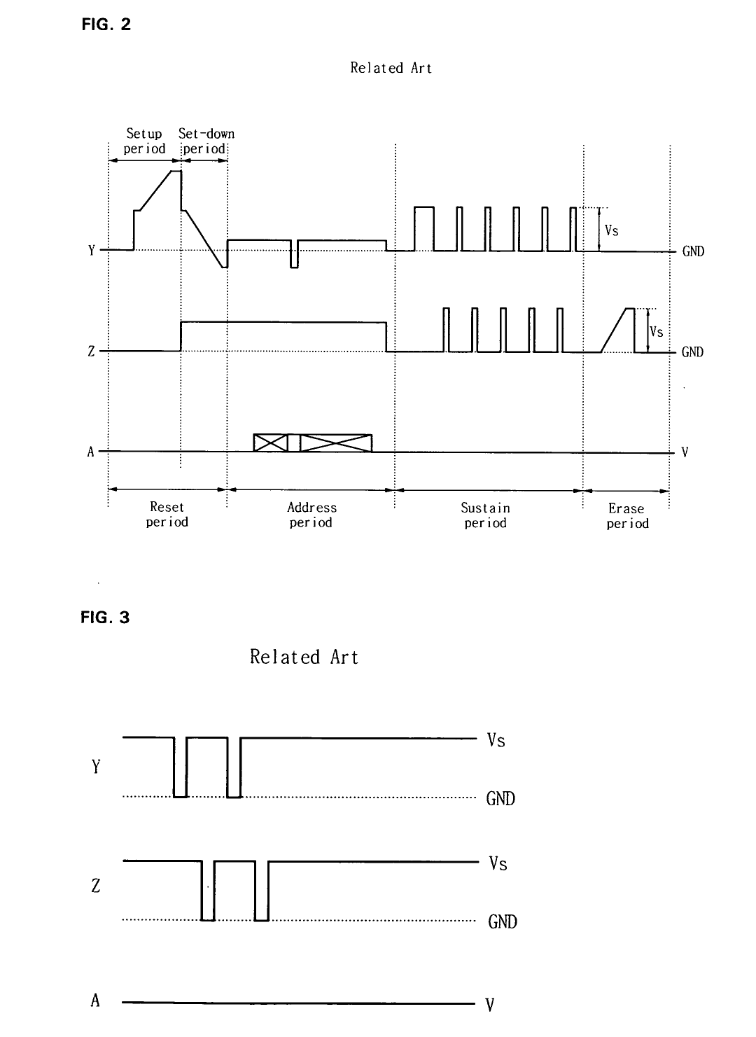

### DETAILED DESCRIPTION

Reference will now be made in detail embodiments of the invention examples of which are illustrated in the accompanying drawings.

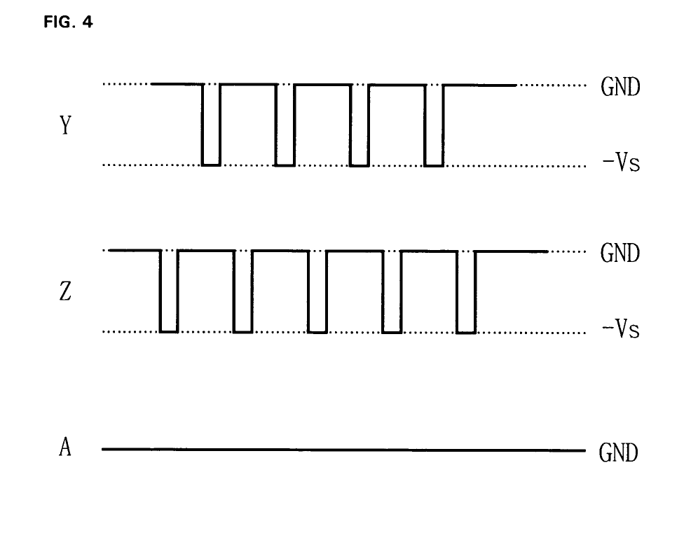

FIG. 4 illustrates waveforms of a negative sustain driving in a sustain period in accordance with the present invention.

As shown in FIG. 4, the present invention provides a driving method for a plasma display panel using negative sustain voltage −Vs, wherein the negative sustain voltage −Vs and the ground level voltage GND are alternately applied to each of a scan electrode Y and a sustain electrode Z in a sustain period, and the negative sustain voltage −Vs is first applied to the sustain electrode Z. The negative voltage can range from −160V to −200V.

That is, as shown in FIG. 4, in accordance with the present invention, a negative biased sustain voltage is applied in the sustain period, and particularly, the sustain voltage is first applied to a common sustain electrode Z.

This is performed in consideration of polarity of wall charges formed after addressing has been completed, and implies that electrons in the common sustain electrode Z are formed as wall charges.

At this time, the driving method of the present invention can be performed more effectively when a gap between a scan electrode and a sustain electrode provided on an upper substrate within the discharge cell can be greater than a height of the barrier rib. More desirably, the gap between the scan electrode 901 and the sustain electrode is within a range of about 100 μm to 400 μm. A structure having the gap ranging from about 100 μm to 400 μm between the scan electrode and the sustain electrode is defined as a long gap structure.

That the gap ranges from about 100 μm to 400 μm between the scan electrode and the sustain electrode is to provide the long gap structure plasma display panel and make a positive column region of a discharge region available, thereby maximizing a discharge efficiency of the plasma display panel. More desirably, the gap ranges from about 150 μm to 350 μm between the scan electrode and the sustain electrode.

Accordingly, it is possible to reduce the minimum sustain voltage more in comparison with the waveforms in the related art by applying the waveforms of the present invention shown in FIG. 4.

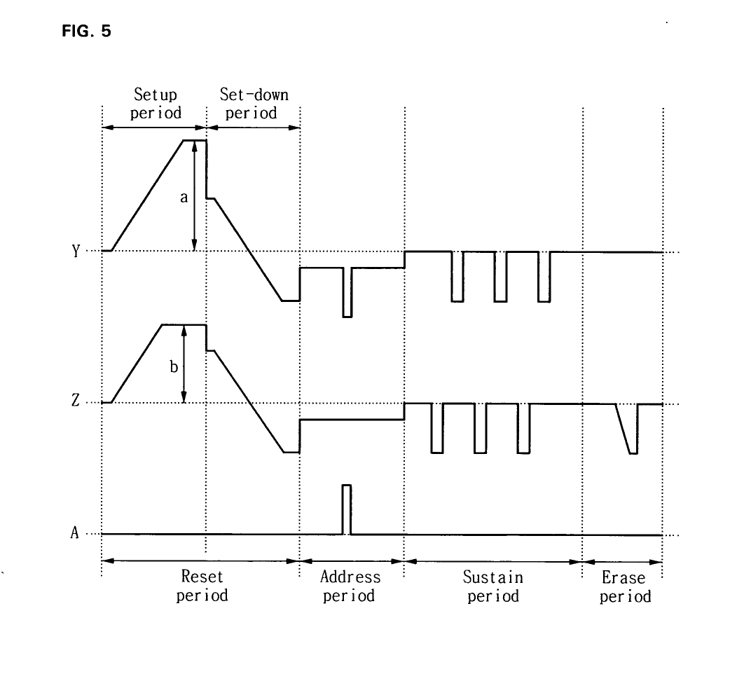

FIG. 5 illustrates waveforms in a negative sustain driving method in accordance with an embodiment of the present invention.

As shown in FIG. 5, voltage waveforms having the same polarity are applied to the scan electrode Y and the sustain electrode Z in the reset period of the present invention. At this time, the voltage having the same polarity applied to each of the scan electrode Y and the sustain electrode Z is positive voltage.

That is, polarities of the voltages applied to the scan electrode Y and the sustain electrode Z in the reset period of the driving waveform sustained in a negative bias, particularly, in the setup period are same. In other word, it is characterized in that the polarities of the voltages applied to the scan electrode Y and the sustain electrode Z are the same-positive, as shown in FIG. 5.

When the two electrodes Y and Z are same in polarity, discharge between the two electrodes Y and Z is suppressed and opposed discharge between the two electrodes and the address electrode A is ready to occur.

Further, in the voltage applied to each of the scan electrode Y and the sustain electrode Z in the reset period, the voltage a applied to the scan electrode Y is higher than the voltage b applied to the sustain electrode Z (a>b).

Accordingly, when voltages having the same polarity are applied to the scan electrode Y and the sustain electrode Z in the reset period, particularly, in the setup period mentioned above, it is characterized in that the voltage applied to the scan electrode Y is higher than that applied to the sustain electrode Z.

This is indicated in the size of arrow in FIG. 5. Since the wall charges which are excessively accumulated in the sustain electrode Z in the course of accumulating wall charges by the opposed discharge in the setup period may generate erroneous discharge, wall charges accumulated in the sustain electrode Z are controlled.

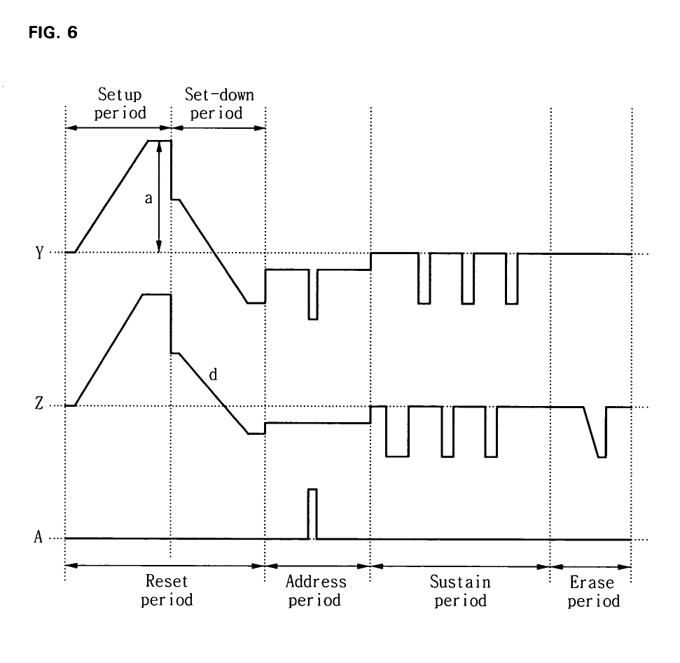

FIG. 6 illustrates waveforms in a negative sustain driving method in accordance with another embodiment of the present invention.

As shown in FIG. 6, in the falling voltage in a setdown period of a reset period according to the present invention, the falling voltage applied to the scan electrode Y is higher than that applied to the sustain electrode Z.

At this time, as described above, the voltage waveform having the same positive polarity is applied to each of the scan electrode Y and the sustain electrode Z in the reset period according to the present invention, wherein the voltage a applied to the scan electrode Y is higher than the voltage b applied to the sustain electrode Z.

Further, the incline d of the sustain electrode Z is easier than the incline c of the scan electrode Y.

At this time, it is desired that the falling incline velocity of the falling voltage is 2V/μm. By doing so, it is possible to more finely control the wall charges in the sustain electrode Z and accordingly, obtain a sufficient driving margin. Further, it is possible to obtain a more stable control with a low power.

As such, since it is possible to generate reset discharge during the setup period using the negative sustain voltage −Vs, it is possible to more efficiently save consumption power in comparison with the reset discharge in the related art in which a high voltage is used.

Further, since it is possible to prevent occurrence of reactive power in the panel caused by high voltage, it is possible to construct a more efficient plasma display panel.

As described above, the negative sustain driving according to the present invention can be obtained at a voltage, −Vs, which is remarkably lower than the voltage of the negative sustain driving in the related art. Further, consumption power is reduced and power added efficiency is increased by reducing the driving voltage of PDP. Particularly, PDP having a long gap structure whose electrode gap is more than 100 can be efficiently and stably driven by making the driving voltage lower.

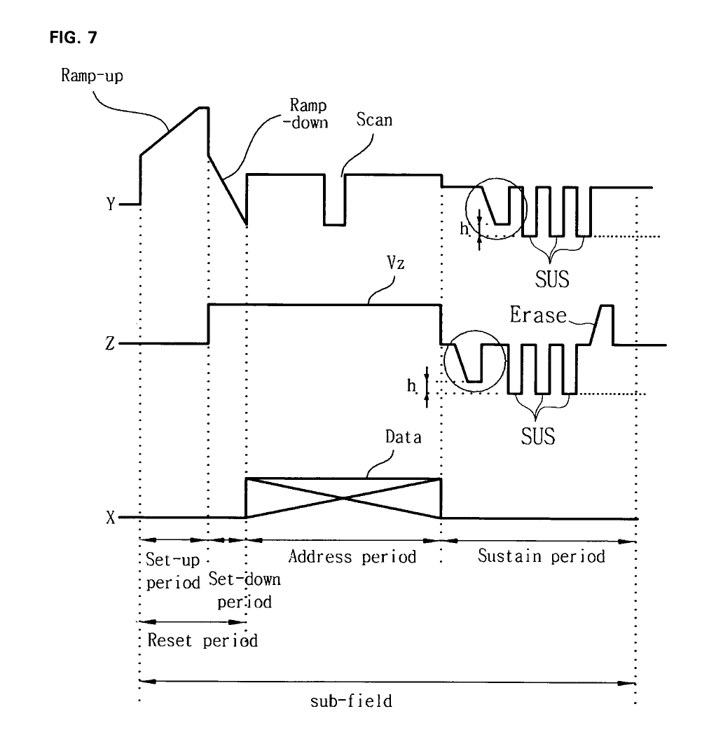

FIG. 7 illustrates waveforms in a negative sustain driving method in accordance with still another embodiment of the present invention As illustrated in FIG. 7, a method of driving a plasma display panel according to an embodiment of the present invention is driven with it being divided into a reset period in which the entire cells are reset, an address period in which cells to be discharged are selected, a sustain period in which the discharge of selected cells is sustained, and an erase period in which wall charges within discharged cells are erased.

In a set-up period of the reset period, a ramp-up waveform Ramp-up is applied to the entire scan electrodes. The ramp-up waveform generates a weak dark discharge within discharge cells of the entire screen. The set-up discharge causes positive wall charges to be accumulated on the address electrodes and the sustain electrodes and negative wall charges to be accumulated on the scan electrodes.

After the ramp-up waveform is supplied, in a set-down period of the reset period, a ramp-down waveform Ramp-down, which falls from a positive voltage lower than a peak voltage of the ramp-up waveform to a predetermined voltage level lower than a ground (GND) level voltage, generates a weak erase discharge within the discharge cells, thereby sufficiently erasing wall charges excessively formed on the scan electrodes. The set-down discharge causes wall charges to uniformly remain within the discharge cells to the extent that an address discharge can be stably generated.

In the address period, while a negative scan pulse is sequentially applied to the scan electrodes, a positive data pulse is applied to the address electrodes in synchronization with the scan pulse. As a voltage difference between the scan pulse and the data pulse and a wall voltage generated in the reset period are added, an address discharge is generated within discharge cells to which the data pulse is applied. Further, wall charges of the degree that a discharge can be generated when the sustain voltage Vs is applied are formed within cells selected by the address discharge.

Furthermore, in the address period, the positive voltage Vz is applied to the sustain electrodes such that erroneous discharge is not generated between the sustain electrodes and the scan electrodes by reducing a voltage difference between the sustain electrodes and the scan electrodes in at least one of the set-down period and the address period.

In the sustain period, a negative sustain voltage −Vs is alternately applied to the scan electrodes and the sustain electrode. Applying a negative sustain voltage −Vs to a sustain electrode and then a scan electrode during a sustain period. As a wall voltage within cells and the sustain voltage Vs are added, a sustain discharge, that is, a display discharge is generated between the scan electrodes and the sustain electrode in cells selected by the address discharge whenever the negative sustain pulse is applied.

After the sustain discharge is completed, a voltage of an erase ramp waveform (Erase) having a narrow pulse width and a low voltage level is applied to the sustain electrode in the erase period, thereby erasing wall charges that remain within the cells of the whole screen.

In particular, unlike the related art, in the method of driving the plasma display panel according to an embodiment of the present invention, applying a negative sustain voltage −Vs to a sustain electrode and then a scan electrode during a sustain period and applying a negative sustain ramp pulse having a voltage of a magnitude, that is less than a magnitude of the negative sustain voltage −Vs, to the sustain electrode before applying the negative sustain voltage −Vs to the sustain electrode.

Thus, a difference in wall charges of respective sub-discharge cells, which are formed due to opposite discharge occurring in the address period, can be reduced. Accordingly, there are advantages in that erroneous discharge and excessive discharge can be controlled, sustain discharge generated in the sustain period can be stabilized, and a difference in optical waveforms can be reduced.

In this case, the sustaining period of the negative sustain ramp pulse Ramp is set in the range of 5 μs or less. This is because when the sustaining period of the negative sustain ramp pulse Ramp exceeds 5 μs, the sustain period is lengthened and driving margin for sustain discharge is decreased.

Further, according to an embodiment of the present invention, it is preferred that the first negative sustain voltage −Vs comprising the negative sustain ramp pulse Ramp applied to the scan electrodes Y and the sustain electrode Z be applied beginning the sustain electrode Z. This is because as the positive voltage Vz has been supplied to the sustain electrode Z in the address period before the sustain period begins, the state of wall charges formed in the address period can be changed rapidly for rapid driving by applying the negative sustain voltage −Vs.

Furthermore, according to an embodiment of the present invention, a difference between the magnitude of the voltage of the negative sustain ramp pulse and the magnitude of the negative sustain voltage range from 5V to 20V.

Accordingly, sustain discharge generated by the same voltage level can be controlled more easily, and the influence of an absolute value voltage on phosphors can be further decreased by applying the absolute value voltage lower than the sustain voltage −Vs.

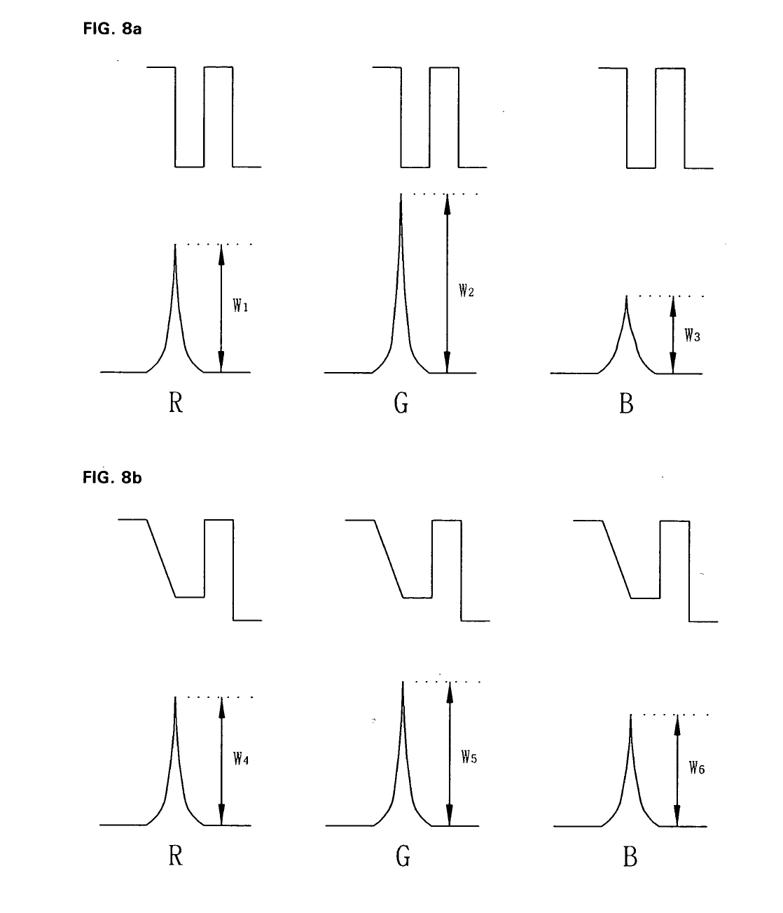

FIGS. 8a and 8b are a view for comparing light waveforms in a negative sustain driving waveform in accordance with embodiments of the present invention.

FIG. 8a is a view illustrating the degree that optical waveforms bounce at the time of sustain discharge, which appears depending on a negative sustain driving waveform of a conventional plasma display panel. FIG. 9b is a view illustrating the degree that optical waveforms bounce at the time of sustain discharge, which appears depending on a negative sustain driving waveform of the present invention.

Referring to FIG. 9a, sub-discharge cells, that is, R, G and B discharge cells are coated with phosphors having different emission characteristics. In this case, when the sustain period begins, the first negative sustain pulse is vertically applied to generate erroneous discharge and excessive discharge due to the ratio of abrupt voltage change per time.

Accordingly, sustain discharge is made unstable, and the optical waveforms are greatly influenced. As a result, a difference in peak values W1, W2 and W3 of optical waveforms every R, G and B discharge cells having different emission characteristic becomes profound. If a difference in the optical waveforms every R, G and B discharge cells is great, phosphor having a high peak value of an optical waveform, for example, the green (G) in FIG. 8a emits more greatly, so that white balance is difficult and pure white is difficult to implement.

In contrast, referring to FIG. 8b, sub-discharge cells, that is, R, G and B discharge cells are coated with phosphors having different emission characteristics. applying a negative sustain ramp pulse having a voltage of a magnitude, that is less than a magnitude of the negative sustain voltage, to the sustain electrode before applying the negative sustain voltage to the sustain electrode. That is, the ratio of voltage change per hour, of the first negative sustain voltage −Vs, is reduced. It is therefore possible to control erroneous discharge and excessive discharge. Consequently, sustain discharge can be generated stably, and the influence on optical waveforms can be minimized.

Therefore, although the sub-discharge cells have different emission characteristics, a difference in the peak values W4, W5 and W6 of the optical waveform is relatively decreased due to stable sustain discharge. It is therefore possible to improve the balance of colors R, G and B and implement pure white.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to the present invention, the ramp pulse is included in the first negative sustain pulse applied to the plasma display panel in the sustain period. Accordingly, a difference in optical waveforms of respective sub-discharge cell phosphors that emit in the sustain period can be reduced, and sustain discharge can be stabilized.

Furthermore, according to the present invention, the ramp pulse is included in the first negative sustain pulse applied to the plasma display panel in the sustain period. Accordingly, a difference in optical waveforms of respective sub-discharge cell phosphors that emit in the sustain period can be reduced. It is therefore possible to control erroneous discharge and excessive discharge and implement pure white.

What is claimed is:

1. A method of driving a plasma display panel comprising:
alternately applying a negative sustain voltage and a ground level voltage to each of a scan electrode and a sustain electrode during a sustain period,
wherein the negative sustain voltage is first applied to the sustain electrode.

2. The method of claim 1, wherein the scan electrode and the sustain electrode are spaced with a predetermined gap therebetween.

3. The method of claim 2, wherein the gap between the scan electrode and the sustain electrode ranges from 100 μm to 400 μm.

4. The method of claim 1, wherein voltage having the same polarity are applied to each of the scan electrode and the sustain electrode during a reset period.

5. The method of claim 4, wherein the voltages having the same polarity applied to the scan electrode and the sustain electrode are positive voltages.

6. The method of claim 5, wherein, in the voltages applied to the scan electrode and the sustain electrode in the reset period, the voltage applied to the scan electrode is higher than the voltage applied to the sustain electrode.

7. The method of claim 1, wherein, in falling voltages in a setdown period of the reset period, the voltage applied to the scan electrode is higher than that applied to the sustain electrode, and the slope of the sustain electrode is easier than that of the scan electrode.

8. The method of claim 7, wherein the slope of the falling voltage is 2V/μm or less.

9. The method of claim 1, wherein before applying the negative sustain voltage to the sustain electrode, a negative sustain ramp pulse having a magnitude, that is less than a magnitude of the negative sustain voltage, is applied to the sustain electrode.

10. A method of driving a plasma display panel comprising:
applying a negative sustain voltage to a sustain electrode and then a scan electrode during a sustain period; and
applying a negative sustain ramp pulse having a voltage of a magnitude, that is less than a magnitude of the negative sustain voltage, to the sustain electrode before applying the negative sustain voltage to the sustain electrode.

11. The method of claim 10, wherein a gap between the scan electrode and the sustain electrode is more than a height of a barrier rib partitioning a discharge cell.

12. The method of claim 10, wherein the gap between the scan electrode and the sustain electrode ranges from 100 μm to 400 μm.

13. The method of claim 10, wherein the gap between the scan electrode and the sustain electrode ranges from 150 μm to 350 μm.

14. The method of claim 10, wherein the negative sustain ramp pulse is maintained for a period of time equal to or less than 5 μs.

15. The method of claim 10, wherein a difference between the magnitude of the voltage of the negative sustain ramp pulse and the magnitude of the negative sustain voltage ranges from 5V to 20V.
